(19) United States
(12) Patent Application Publication
(10) Pub. No.: US 2013/0178356 A1
(43) Pub. Date: Jul. 11, 2013

(54) ABSORBENT FOR HEAVY METAL AND FILTER DEVICE INCLUDING THE SAME

(71) Applicants: Hyun Seok Kim, Seoul (KR); Bok Soon Kwon, Seoul (KR); Dong Jin Ham, Anyang-si (KR); Hyo Rang Kang, Anyang-si (KR); Joon Seon Jeong, Seoul (KR)

(72) Inventors: Hyun Seok Kim, Seoul (KR); Bok Soon Kwon, Seoul (KR); Dong Jin Ham, Anyang-si (KR); Hyo Rang Kang, Anyang-si (KR); Joon Seon Jeong, Seoul (KR)

(73) Assignee: SAMSUNG ELECTRONICS CO., LTD., Suwon-si (KR)

(21) Appl. No.: 13/555,651

(22) Filed: Jul. 23, 2012

(30) Foreign Application Priority Data
Jan. 6, 2012 (KR) 10-2012-0001952

(51) Int. Cl. B01J 20/02; B01J 20/04; B01J 20/30; B01J 20/24; B01J 20/26; B01J 20/22; B01J 20/10

(52) U.S. Cl. 502/5; 502/400; 502/401; 502/414; 502/406; 502/407; 423/700; 502/404; 502/402

(57) ABSTRACT

A heavy metal absorbent, and a filter device including the same, include heavy metal absorbing particles each having a surface with a —NOₓ (1≦x≦2) functional group. The heavy metal absorbing particles are one selected from inorganic oxide particles, graphite-based carbon particles, and a combination thereof.

### CROSS-REFERENCE TO RELATED APPLICATION

This application claims priority to and the benefit of Korean Patent Application No. 10-2012-0001952 filed in the Korean Intellectual Property Office on Jan. 6, 2012, the entire contents of which are incorporated herein by reference.

### BACKGROUND

1. Field

A heavy metal absorbent and a filter device including the same are disclosed.

2. Description of the Related Art

The demand for heavy metals is increasing day by day due to rapid industrialization along with economic growth. Most heavy metals not only have a variety of influences on the human body and the ecosystem, but also are serious pollutants to the environment (e.g., rivers and/or soil pollutants).

Water pollution due to reckless heavy metal discharge has been a global problem for several decades. Hazardous metal elements that have adverse effects on the human body and the ecosystem include arsenic (As), chromium (Cr), copper (Cu), lead (Pb), mercury (Pb), manganese (Mn), cadmium (Cd), nickel (Ni), and the like. For example, arsenic (As), among the heavy metals, is poisonous to the human body, and arsenic present in rocks or the underground geological stratum may naturally dissolve into underground water. At present, absorbents formed of alumina, granular ferric hydroxide (GFH), and ferric oxides are widely used as arsenic-removing filters, but their absorption capacity is not satisfactory. Therefore, there is a need for an absorbent that more effectively removes heavy metals.

### SUMMARY

A heavy metal absorbent and a filter device including the same are disclosed.

Example embodiments provide a heavy metal absorbent having excellent heavy metal absorption/removal performance.

Other example embodiments provide a filter device including the heavy metal absorbent.

According to example embodiments, a heavy metal absorbent includes a plurality of heavy metal absorbing particles each including a surface with a —NOₓ (1≦x≦2) functional group, wherein the plurality of heavy metal absorbing particles are one selected from a plurality of inorganic oxide particles, a plurality of graphite-based carbon particles, and a combination thereof.

The inorganic oxide particles may be metal oxide particles including a metal selected from a transition element, a rare earth element, an alkali metal, an alkaline-earth metal, a Group 13 element (IUPAC periodic table), a Group 14 element (IUPAC periodic table), and a combination thereof. The inorganic oxide particles may include one selected from TiO₂, Al₂O₃, Fe₂O₃, SiO₂, CuO, Cu₂O, ZrO₂, zeolite, and a combination thereof. The zeolite may be selected from zeolite-A, ZSM-5, zeolite-X, zeolite-Y, zeolite-L, LTA (Linde type A) zeolite, RHO zeolite, PAU zeolite, KFI zeolite, and a combination thereof.

The —NOₓ (1≦x≦2) functional group may be present in an amount of about 0.5 moles to about 5 moles based on about 100 moles of the plurality of heavy metal absorbing particles.

The heavy metal absorbent may be a nanoparticle having a particle size of about 1 nm to about 100 nm. The heavy metal absorbent may have a specific surface area of greater than, or equal to, about 10 m²/g.

The heavy metal absorbent may further include a binder selected from a silicate, a cellulose polymer, a vinyl-based polymer, and a combination thereof.

The heavy metal absorbent may be an arsenic absorbent. The absorbent may have an arsenic absorption performance of greater than, or equal to, about 2.0 mg/g.

The —NOₓ (1≦x≦2) functional group may be on the surface of the plurality of heavy metal absorbing particles.

The —NOₓ (1≦x≦2) functional group may be attached to the surface of the plurality of heavy metal absorbing particles.

According to example embodiments, a method of manufacturing a heavy metal absorbent includes treating a plurality of heavy metal absorbing particles with a nitric acid solution to introduce a —NOₓ (1≦x≦2) functional group on a surface of the plurality of heavy metal absorbing particles.

The inorganic oxide particles may be metal oxide particles including a metal selected from a transition element, a rare earth element, an alkali metal, an alkaline-earth metal, a Group 13 element (IUPAC periodic table), a Group 14 element (IUPAC periodic table), and a combination thereof. The inorganic oxide particles may include one selected from TiO₂, Al₂O₃, Fe₂O₃, SiO₂, CuO, Cu₂O, ZrO₂, zeolite, and a combination thereof. The zeolite may be selected from zeolite-A, ZSM-5, zeolite-X, zeolite-Y, zeolite-L, LTA (Linde type A) zeolite, RHO zeolite, PAU zeolite, KFI zeolite, and a combination thereof.

The —NOₓ (1≦x≦2) functional group may be introduced to the plurality of heavy metal absorbing particles by dipping the plurality of heavy metal absorbing particles in an about 0.1 M to about 2 M nitric acid solution, or sprayed with an about 0.1 M to about 2 M nitric acid solution for about 5 minutes to about 2 hours.

Treating the plurality of heavy metal absorbing particles may include surface-treating, or plasma-treating, the plurality of heavy metal absorbing particles.

Plasma-treating the plurality of heavy metal absorbing particles may include using a plasma selected from RF (radio frequency) plasma, microwave plasma, DC (direct current) plasma, AC (alternating current) plasma, capacitive plasma, and inductive plasma.

The plasma may include a gas selected from O₂, N₂, F₂, Ar, NH₃, air, and a mixed gas thereof.

Plasma-treating the plurality of heavy metal absorbing particles may be performed for about 1 minute to about 1 hour.

Treating the plurality of heavy metal absorbing particles may include attaching the —NOₓ (1≦x≦2) functional group to the surface of the plurality of heavy metal absorbing particles.

According to example embodiments, a filter device including the heavy metal absorbent is provided.

### BRIEF DESCRIPTION OF THE DRAWINGS

Example embodiments will be more clearly understood from the following detailed description taken in conjunction with the accompanying drawings. FIGS. 1-4 represent non-limiting, example embodiments as described herein.

FIG. 1 is a schematic view showing the filter device according to example embodiments,

FIGS. 2 and 3 are graphs showing FT-IR analysis results of the heavy metal absorbents according to Examples 7 and 8, and

FIG. 4 is a graph showing FT-IR analysis results of the FT-IR analysis results according to Example 1 and Al(NO₃)₃.7H₂O.

### DETAILED DESCRIPTION

Various example embodiments will now be described more fully with reference to the accompanying drawings in which some example embodiments are shown. However, specific structural and functional details disclosed herein are merely representative for purposes of describing example embodiments. Thus, the invention may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the invention.

In the drawings, the thicknesses of layers and regions may be exaggerated for clarity, and like numbers refer to like elements throughout the description of the figures.

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that, if an element is referred to as being “connected” or “coupled” to another element, it can be directly connected, or coupled, to the other element or intervening elements may be present. In contrast, if an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing. For example, an implanted region illustrated as a rectangle may have rounded or curved features and/or a gradient (e.g., of implant concentration) at its edges rather than an abrupt change from an implanted region to a non-implanted region. Likewise, a buried region formed by implantation may result in some implantation in the region between the buried region and the surface through which the implantation may take place. Thus, the regions illustrated in the figures are schematic in nature and their shapes do not necessarily illustrate the actual shape of a region of a device and do not limit the scope.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In order to more specifically describe example embodiments, various aspects will be described in detail with reference to the attached drawings. However, the present invention is not limited to example embodiments described.

As used herein, the term “combination thereof” may refer to a mixture, a stacked structure, an alloy, and the like.

A heavy metal absorbent and a filter device including the same are disclosed.

A heavy metal absorbent according to example embodiments includes a plurality of heavy metal absorbing particles selected from a plurality of inorganic oxide particles, a plurality of graphite-based carbon particles, and a combination thereof and a —NOₓ (1≦x≦2) functional group on a surface of the heavy metal absorbing particles.

The inorganic oxide particles may be an oxide of a metal selected from a transition element, a rare earth element, an alkali metal, an alkaline-earth metal, a Group 13 element (IUPAC periodic table), a Group 14 element (IUPAC periodic table), and a combination thereof. The inorganic oxide may be selected from TiO₂, Al₂O₃, Fe₂O₃, SiO₂, CuO, Cu₂O, ZrO₂, zeolite, and a combination thereof. The zeolite may be selected from zeolite-A, ZSM-5, zeolite-X, zeolite-Y, zeolite-L, LTA (Linde type A) zeolite, RHO zeolite, PAU zeolite, KFI zeolite, and a combination thereof.

The —NOₓ (1≦x≦2) functional group may be present in an amount of about 0.5 moles to about 5 moles based on 100 moles of the heavy metal absorbing particles. When the —NOₓ (1≦x≦2) functional group is present within the range, it may improve absorption performance of a heavy metal.

The heavy metal absorbent may be a nanoparticle having a particle size of about 1 nm to about 100 nm. The nanoparticle heavy metal absorbent may have a specific surface area of greater than, or equal to, about 10 m²/g, specifically, about 15 m²/g to about 200 m²/g, and more specifically, about 30 m²/g to about 200 m²/g. When the heavy metal absorbent has a particle size and a specific surface area within the above range, the heavy metal absorption sites are more exposed to the surface of the heavy metal absorbent, increasing the absorption area and improving absorption performance.

The heavy metal absorbent may further include a binder selected from a silicate, a cellulose polymer, a vinyl-based polymer, and a combination thereof. Examples of the silicate may include aluminosilicate, sodium silicate, and the like. Examples of the cellulose polymer may include acetyl cellulose, ethylcellulose, nitrocellulose, and the like. Examples of the vinyl-based polymer may include polyvinyl alcohol, a vinyl chloride-vinyl acetate copolymer, vinyl acrylate, vinyl methacrylate, and the like. The binder may be agglomerated with the heavy metal absorbing particles. The binder may be included in an amount of about 1 to about 10 parts by weight based on 100 parts by weight of the heavy metal absorbing particles. When the binder is included within the range, it may combine a plurality of heavy metal absorbing particles as well as maintain an absorption performance of the heavy metal absorbing particles. The heavy metal absorbent may be used to absorb arsenic. The absorbent may have an arsenic absorption performance of greater than, or equal to, about 2.0 mg/g, specifically, greater than, or equal to, about 2.5 mg/g, and more specifically, greater than, or equal to, about 3.0 mg/g.

The heavy metal absorbent has excellent heavy metal absorption/removal performance, and may selectively absorb/remove heavy metal ions present in water but preserve minerals therein and provide drinkable water.

The heavy metal absorbent may be prepared by surface-treating or plasma-treating the heavy metal absorbing particle with a nitric acid solution to introduce a —NOₓ (1≦x≦2) functional group on the surface of the heavy metal absorbing particles.

The surface treatment may be performed by dipping the heavy metal absorbing particle in an about 0.1 M to about 2 M nitric acid solution for about 5 minutes to about 2 hours or spraying an about 0.1 M to about 2 M nitric acid solution. When the surface treatment is performed with a nitric acid solution within the concentration range, a —NOₓ (1≦x≦2) functional group is sufficiently introduced on the surface of the heavy metal absorbing particles.

The plasma may be selected from RF (radio frequency) plasma, microwave plasma, DC (direct current) plasma, AC (alternating current) plasma, capacitive plasma, and inductive plasma.

The plasma treatment may use a gas selected from O₂, N₂, F2, Ar, NH₃, air, and a mixed gas thereof.

The plasma treatment may be performed for about one minute to about one hour.

The plasma treatment may sufficiently introduce a —NOₓ (1≦x≦2) functional group on the surface of a heavy metal absorbing particles.

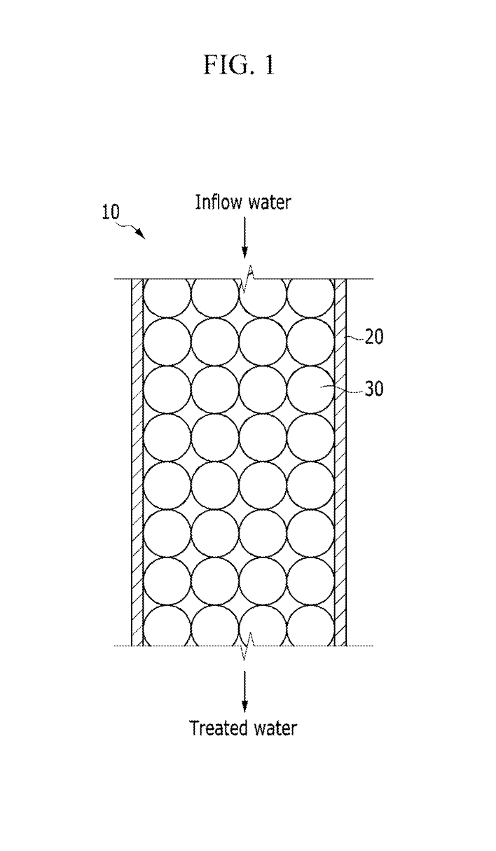

FIG. 1 is a schematic view showing the filter device according to example embodiments.

Referring to FIG. 1, a filter device 10 includes an absorbent 30 filled in a case 20.

The absorbent 30 absorbs heavy metals or chlorine sterilization byproducts that exist in water. The absorbent 30 may adsorb arsenic existing in water in the form of trivalent or pentavalent oxyanion (e.g., H₃AsO₃, H₂AsO₄⁻, and HAsO₄₂⁻). Although FIG. 1 shows a case where the absorbent 30 fills the case 20, the absorbent 30 may coat an interior wall of the case 20 in the form of nanoparticles, and it may be deposited in the form of a thin film.

Hereinafter, example embodiments are illustrated in more detail with reference to examples. However, the following are example embodiments and are not limiting.

### EXAMPLES 1 TO 3

### Heavy Metal Absorbent Prepared Through Surface-Treatment with Nitric Acid Solution

A heavy metal absorbent having a —NOₓ (1≦x≦2) functional group on the surface of the heavy metal absorbing particles is prepared by respectively dipping TiO₂ (P25 from Degussa) as the heavy metal absorbing particles, Al₂O₃ (about 50 nm from Sigma-Aldrich Co. Ltd.), and Fe₂O₃ (about 50 nm from Sigma-Aldrich Co. Ltd.) in a 2 M HNO₃ solution for about 1 hour.

### EXAMPLES 4 TO 6

### Heavy Metal Absorbent Prepared Through Plasma Treatment

A heavy metal absorbent having a —NOₓ (1≦x≦2) functional group on the surface of heavy metal absorbing particles is prepared by respectively treating TiO₂ (P25 from Degussa) as the heavy metal absorbing particles, Al₂O₃ (about 50 nm from Sigma-Aldrich Co. Ltd.) and Fe₂O₃ (about 50 nm from Sigma-Aldrich Co. Ltd.) with RF plasma (RF power: 150 W), O₂ (flow rate: 5 sccm) for about one minute.

### EXAMPLES 7 TO 9

### Heavy Metal Absorbent Prepared Through Plasma Treatment

A heavy metal absorbent having a —NOₓ (1≦x≦2) functional group on the surface of the heavy metal absorbing particles is prepared by respectively treating TiO₂ (P25 from Degussa) as the heavy metal absorbing particles, Al₂O₃ (about 50 nm from Sigma-Aldrich Co. Ltd.), and Fe₂O₃ (about 50 nm from Sigma-Aldrich Co. Ltd.) with RF plasma (RF power: 150 W), O₂ (flow rate: 5 sccm) for about 5 minutes.

### COMPARATIVE EXAMPLES 1 TO 3

### Heavy Metal Absorbent

TiO₂ (P25 from Degussa), Al₂O₃ (about 50 nm from Sigma-Aldrich Co. Ltd.), and Fe₂O₃ (about 50 nm from Sigma-Aldrich Co. Ltd.) are respectively used as a heavy metal absorbent.

### Analysis of Surface Functional Group of Heavy Metal Absorbent

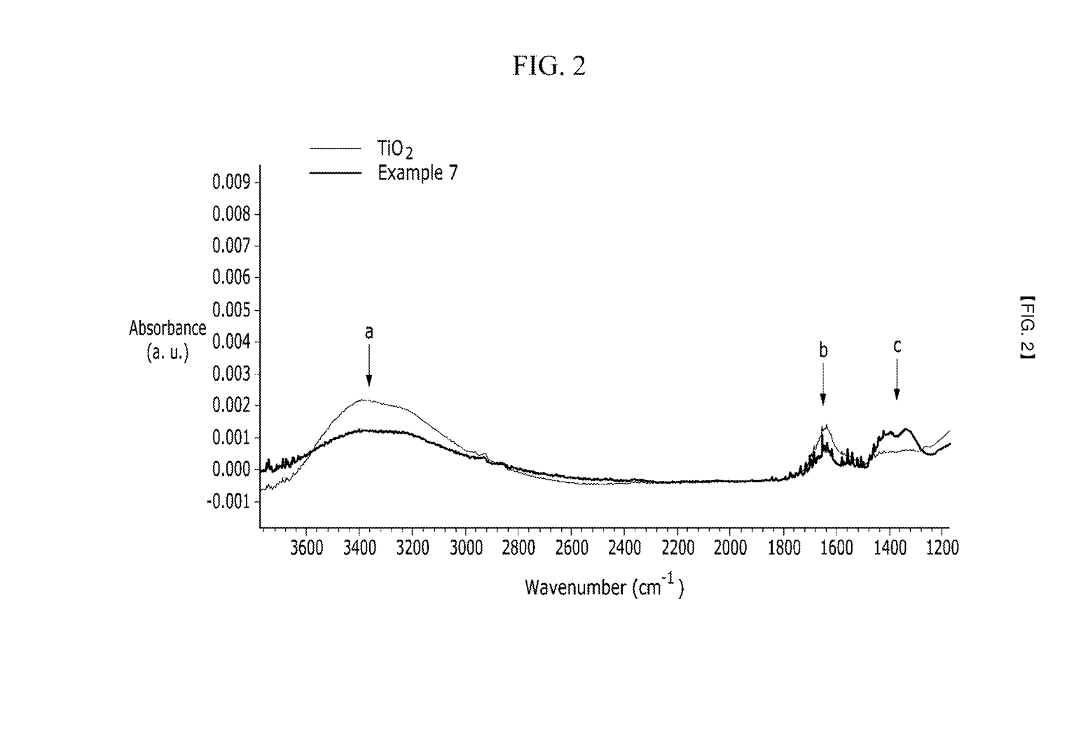

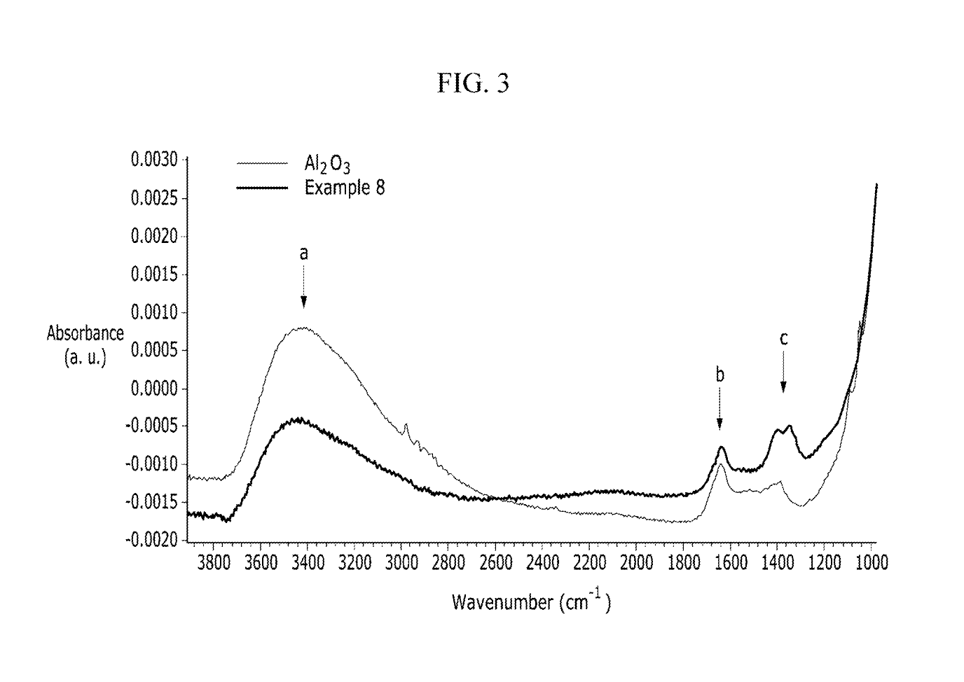

FIGS. 2 and 3 show Fourier Transform Infrared Spectroscopy (FT-IR) analysis results of the heavy metal absorbents according to Examples 7 and 8.

FIGS. 2 and 3 also show TiO₂ and Al₂O₃, respectively, before plasma treatment for comparison.

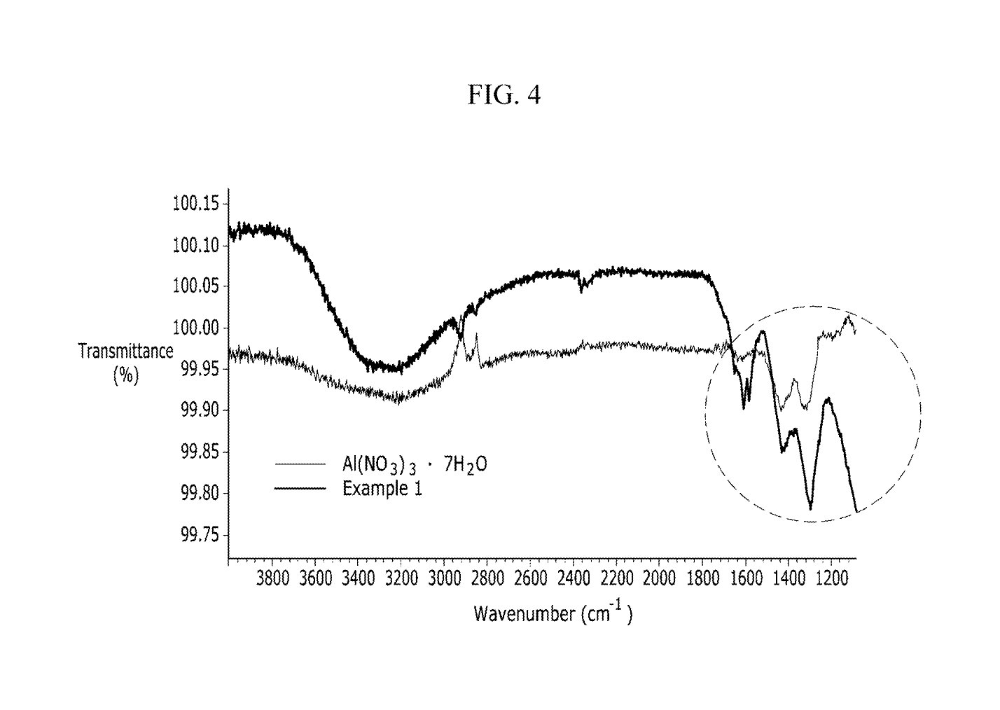

Referring to FIGS. 2 and 3, the heavy metal absorbents according to Examples 7 and 8 have an absorbance peak related to moisture (marked as “a”) at about 3400 cm⁻¹ (—OH stretching) and about 1650 cm⁻¹ (H—O—H bending), and absorption peaks (marked as “b” and “c”) at about 1300-1500 cm⁻¹ that the TiO₂ and Al₂O₃ do not have before plasma treatment. Then, FT-IR analysis of the heavy metal absorbent according to Example 1 and Al(NO₃)₃.7H₂O is performed to check that the peaks (marked as “b” and “c”) shown in FIGS. 2 and 3 are caused by the —NOₓ (1≦x≦2) functional group. The results are shown in FIG. 4.

FIG. 4 is a graph showing FT-IR analysis results of the FT-IR analysis results according to Example 1 and Al(NO₃)₃.7H₂O.

Referring to FIG. 4, the peak at about 1300-1500 cm⁻¹ (marked as a dotted circle) corresponds with the peak of the Al(NO₃)₃.7H₂O, which shows that the heavy metal absorbent according to Example 1 has a —NOₓ a functional group on the surface.

### Heavy Metal Absorption Performance

Raw water having various amounts of arsenic (As) are treated with the heavy metal absorbents according to Examples 1 to 9 and Comparative Examples 1 to 3 for about 48 hours, respectively, to evaluate absorption performance. Table 1 shows the absorption amounts of the heavy metal absorbents according to Examples Example 1, 5, 7, and 8, and Comparative Examples 1 and 2. The absorption amounts are measured using atomic absorption spectroscopy (Perkin-Elmer, AA770).

TABLE 1

| | | | INCREASED |
|---|---|---|---|
| | | | RATIO OF |
| | | | ABSORPTION |
| | | | AMOUNT |
| | AMOUNT OF | ABSORPTION | RELATIVE TO |
| HEAVY METAL | ARSENIC | AMOUNT | COMPARATIVE |
| ABSORBENT | (PPM) | (MG/G) | EXAMPLE 1 |
| COMPARATIVE | 19.8 | 3.45 | — |
| EXAMPLE 1 | | | |
| EXAMPLE 1 | | 4.77 | 38% increase |
| COMPARATIVE | 3.15 | 2.63 | — |
| EXAMPLE 1 | | | |
| EXAMPLE 7 | | 3.46 | 31.6% increase |
| COMPARATIVE | 6.89 | 3.22 | — |
| EXAMPLE 1 | | | |
| EXAMPLE 7 | | 4.43 | 37.6% increase |
| COMPARATIVE | 52.66 | 5 | — |
| EXAMPLE 1 | | | |
| COMPARATIVE | 6.4 | 8.4 | |
| EXAMPLE 2 | | | |
| EXAMPLE 8 | | 10.1 | 20.2% increase |
| COMPARATIVE | 52.1 | 10.0 | |
| EXAMPLE 2 | | | |
| EXAMPLE 5 | | 11.6 | 16% increase |
| EXAMPLE 8 | | 12.9 | 29% increase |

As shown in Table 1, the heavy metal absorbents according to Examples 1, 4, 7, and 8 have greater than, or equal to, about 16% better absorption performance than that of Comparative Examples 1 and 2.

The foregoing is illustrative of example embodiments and is not to be construed as limiting thereof. Although a few example embodiments have been described, those skilled in the art will readily appreciate that many modifications are possible in example embodiments without materially departing from the novel teachings and advantages. Accordingly, all such modifications are intended to be included within the scope of this invention as defined in the claims. In the claims, means-plus-function clauses are intended to cover the structures described herein as performing the recited function, and not only structural equivalents but also equivalent structures. Therefore, it is to be understood that the foregoing is illustrative of various example embodiments and is not to be construed as limited to the specific embodiments disclosed, and that modifications to the disclosed embodiments, as well as other embodiments, are intended to be included within the scope of the appended claims.

<Description of Symbols>

| | |
|---|---|
| 10: filter device | 20: case |
| 30: absorbent | |

What is claimed is:

1. A heavy metal absorbent, comprising:
a plurality of heavy metal absorbing particles each including a surface with a —NOₓ (1≦x≦2) functional group, wherein the plurality of heavy metal absorbing particles are one selected from a plurality of inorganic oxide particles, a plurality of graphite-based carbon particles, and a combination thereof.

2. The heavy metal absorbent of claim 1, wherein the inorganic oxide particles are metal oxide particles including a metal selected from a transition element, a rare earth element, an alkali metal, an alkaline-earth metal, a Group 13 element (IUPAC periodic table), a Group 14 element (IUPAC periodic table), and a combination thereof.

3. The heavy metal absorbent of claim 1, wherein the inorganic oxide particles include one selected from TiO₂, Al₂O₃, Fe₂O₃, SiO₂, CuO, Cu₂O, ZrO₂, zeolite, and a combination thereof.

4. The heavy metal absorbent of claim 3, wherein the zeolite is selected from zeolite-A, ZSM-5, zeolite-X, zeolite-Y, zeolite-L, LTA (Linde type A) zeolite, RHO zeolite, PAU zeolite, KFI zeolite, and a combination thereof.

5. The heavy metal absorbent of claim 1, wherein the —NOₓ (1≦x≦2) functional group is present in an amount of about 0.5 moles to about 5 moles based on about 100 moles of the plurality of heavy metal absorbing particles.

6. The heavy metal absorbent of claim 1, wherein the heavy metal absorbent is a nanoparticle having a particle size of about 1 nm to about 100 nm.

7. The heavy metal absorbent of claim 1, wherein the heavy metal absorbent has a specific surface area of greater than, or equal to, about 10 m²/g.

8. The heavy metal absorbent of claim 1, further comprising a binder selected from the group consisting of a silicate, a cellulose polymer, a vinyl-based polymer, and a combination thereof.

9. The heavy metal absorbent of claim 1, wherein the heavy metal absorbent is an arsenic absorbent.

10. The heavy metal absorbent of claim 13, wherein the heavy metal absorbent has an arsenic absorption performance of greater than, or equal to, about 2.0 mg/g.

11. The heavy metal absorbent of claim 1, wherein the —NOₓ (1≦x≦2) functional group is on the surface of the plurality of heavy metal absorbing particles.

12. The heavy metal absorbent of claim 1, wherein the —NOₓ (1≦x≦2) functional group is attached to the surface of the plurality of heavy metal absorbing particles.

13. A method of manufacturing a heavy metal absorbent, comprising:
treating a plurality of heavy metal absorbing particles with a nitric acid solution to introduce a —NOₓ (1≦x≦2) functional group on a surface thereof,
wherein the plurality of heavy metal absorbing particles are selected from a plurality of inorganic oxide particles, a plurality of graphite-based carbon particles, and a combination thereof.

14. The method of claim 13, wherein the inorganic oxide is a metal oxide including a metal selected from a transition element, a rare earth element, an alkali metal, an alkaline-earth metal, a Group 13 element (IUPAC periodic table), a Group 14 element (IUPAC periodic table), and a combination thereof.

15. The method of claim 13, wherein the inorganic oxide is selected from TiO₂, Al₂O₃, Fe₂O₃, SiO₂, CuO, Cu₂O, ZrO₂, zeolite, and a combination thereof.

16. The method of claim 15, wherein the zeolite is selected from zeolite-A, ZSM-5, zeolite-X, zeolite-Y, zeolite-L, LTA (Linde type A) zeolite, RHO zeolite, PAU zeolite, KFI zeolite, and a combination thereof.

17. The method of claim 13, wherein the —NOₓ (1≦x≦2) functional group is introduced by dipping the plurality of heavy metal absorbing particles in an about 0.1 M to about 2 M nitric acid solution for about 5 minutes to about 2 hours or spraying the nitric acid solution.

18. The method of claim 13, wherein treating the plurality of heavy metal absorbing particles includes surface-treating or plasma-treating the plurality of heavy metal absorbing particles.

19. The method of claim 18, wherein plasma-treating the plurality of heavy absorbing particles includes using a plasma is selected from RF (radio frequency) plasma, microwave plasma, DC (direct current) plasma, AC (alternating current) plasma, capacitive plasma, and inductive plasma.

20. The method of claim 19, wherein the plasma includes a gas selected from O₂, N₂, F₂, Ar, NH₃,air, and a mixed gas thereof.

21. The method of claim 18, wherein the plasma-treating the plurality of heavy absorbing particles is performed for about 1 minute to about 1 hour.

22. The method of claim 13, wherein treating the plurality of heavy metal absorbing particles include attaching the —NOₓ (1≦x≦2) functional group to the surface of the plurality of heavy metal absorbing particles.

23. A filter device, comprising:
the heavy metal absorbent according to claim 1.
